(19) United States
(12) Patent Application Publication
(10) Pub. No.: US 2026/0184161 A1
(43) Pub. Date: Jul. 2, 2026

(54) Planetary Surface Rover And EV Wheel Drive

(71) Applicant: Avar Robotics, Inc., Brooklyn, NY (US)

(72) Inventor: Stephen E. Delaporte, Devon, PA (US)

(21) Appl. No.: 19/006,938

(22) Filed: Dec. 31, 2024

Related U.S. Application Data
(60) Provisional application No. 63/616,761, filed on Jan. 1, 0001.

(51) Int. Cl. B60K 17/04; F16H 37/04

(52) U.S. Cl. CPC B60K 17/046; F16H 37/04

(57) ABSTRACT

A planetary surface rover is provided with a variable speed transmission dedicated to each wheel drive such that it can switch its gear reduction ratio either manually or automatically using a gear selection mechanism that may switch between different strain-wave gearing sets, epicyclic gearing sets, cycloidal gearing sets, standard gear train sets, or between each of the different gear sets described. A cable deployment system for a planetary surface rover is also provided which can load a cable spool and then replace a cable spool once the cable has been fully deployed, as well as feed the cable into its own dedicated deployment system which can ultimately then feed the cable along the surface of the celestial body that the rover has been deployed to as it traverses various terrains. These cables may be used for power infrastructure on the Moon or Mars to connect solar panel arrays with charging stations and other applications such as fixed building structures.

### CROSS REFERENCE TO RELATED APPLICATIONS

This application claims the benefit of U.S. Provisional Patent Application No. 63/616,761, filed on Dec. 31, 2023, which is incorporated in its entirety herein by reference.

### FIELD OF THE INVENTION

The present invention relates generally to rovers and electric vehicle wheel drives, and more particularly to a planetary rover or a terrestrially operated electric vehicle that utilizes a dedicated transmission for each wheel drive that can manually or automatically select different gear sets.

### BACKGROUND OF THE INVENTION

The use of planetary exploration rovers on celestial bodies external to Earth date back to the early 1970s with rovers being deployed and operational through NASA's Apollo missions on the Moon, which include Apollo 15, Apollo 16, and Apollo17, and most recently with NASA's Mars Perseverance rover which was first operational on Mars starting in 2021. While these rovers have evolved greatly over the decades, their integrated wheel drives have continued to be implemented with fixed gear reduction ratios. For example, a Mars rover wheel drive utilizes a Maxon motor with a multi-stage planetary gear set that also includes a strain-wave or harmonic drive to provide a fixed speed range and torque output. Similarly, with electric vehicle wheel drives, the emergence of multi-speed gear ratio outputs has only been a recent development that typically operates by driving multiple wheel drives at once rather than each wheel drives individually.

One of the primary advantages to using a multi-speed transmission with different gear sets is that it can provide greater energy efficiency and versatility due to the fact that various terrains and modes of operation can require different torque and speed outputs to optimize the amount of power that the motor has to exert in order to move the rover. With the operation of rovers on celestial bodies such as the Moon or Mars, power conservation is especially crucial since these rovers may only operate for a limited period of time until they are recharged from local solar panel power generation intermittently.

There is therefore a need for a planetary rover that implements a compact transmission that can adjust its output of torque and speed through a gear selection mechanism, whereby each transmission may be dedicated to each wheel drive to assist with the rover's optimization of travel across different terrains and for improving energy efficiency and longevity of each daily mission that the rover is tasked with. Similarly, there is a need for a variable speed transmission that can be dedicated to each wheel drive for terrestrially operated electric vehicles in order to optimize operation, power output, and overall energy efficiency.

### SUMMARY OF EMBODIMENTS OF THE INVENTION

A planetary surface rover is provided with a variable speed transmission dedicated to each wheel drive such that it can switch its gear reduction ratio either manually or automatically using a gear selection mechanism that may switch between different strain-wave gearing sets, epicyclic gearing sets, cycloidal gearing sets, standard gear train sets, or between each of the different gear sets described. A cable deployment system for a planetary surface rover is also provided which can load a cable spool and then replace a cable spool once the cable has been fully deployed, as well as feed the cable into its own dedicated deployment system which can ultimately then feed the cable along the surface of the celestial body that the rover has been deployed to as it traverses various terrains. These cables may be used for power infrastructure on the Moon or Mars to connect solar panel arrays with charging stations and other applications such as fixed building structures. The transmission utilized for the wheel drive of the rover may also be used for the cable winch to provide greater torque when the wound cable is fully loaded.

An electric vehicle for terrestrial operation is also provided that similarly uses a variable speed transmission for each dedicated wheel drive or combinations of single or dual wheel drive transmissions that can manually or automatically select between different strain-wave gearing sets, epicyclic gearing sets, cycloidal gearing sets, standard gear train sets, or between each of the different gear sets described.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a planetary surface rover with a variable speed transmission dedicated to each wheel.

FIG. 2 is a detail of the planetary rover's wheel drive highlighting the forward and backward drive transmission and the turning drive transmission above.

FIG. 3 is a partially exploded view of the variable speed transmission for the rover's wheel drive highlighting the two gear sets that are engaged through a gear selection clutch.

FIG. 4 shows the same rover as in FIG. 1, but with solar panels integrated and a winch and cable deployment system.

FIG. 5 illustrates the back side of the rover shown in FIG. 4 to highlight the cable deployment output feed system.

FIG. 6 shows the underside of the same rover shown in FIGS. 4 and 5 to better highlight its cable deployment system as well as its sensor and electronics housing.

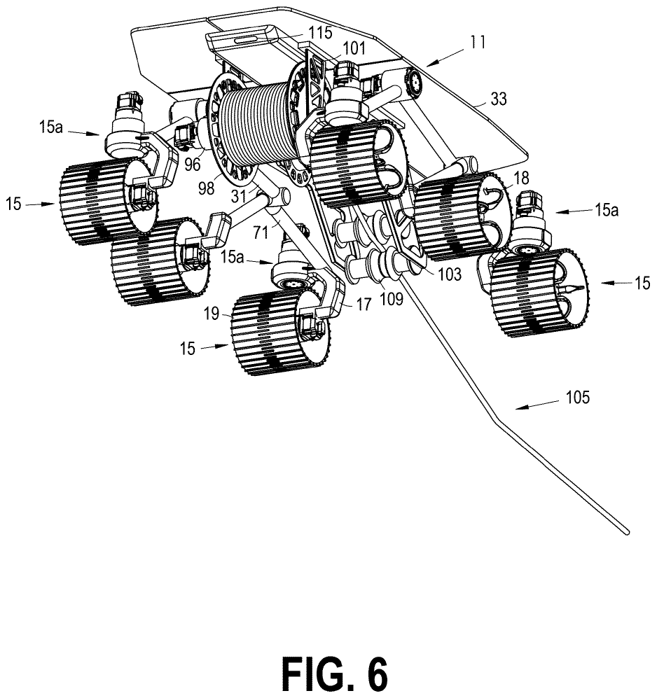

FIG. 7 shows the cable spool loading system in a three phase sequence where the emptied spool is ejected from the rover.

FIG. 8 shows the cable spool loading system in a three phase sequence where the fully wound cable spool is loaded to the rover.

FIG. 9 shows the rover without its top structure to highlight how the cable spool loader operates by lifting the cable spool into place where its shown in a retracted state in the top diagram and in an extended state to load the cable spool in the second diagram.

FIG. 10 shows a side sectional view of the rover and cable spool loader in a extended loading state from the top diagram with a robotic arm shown to the right guiding the cable into the deployment feed system, and then below with cable spool loader retracted and the robot arm further guiding the cable into the deployment feed system.

FIG. 11 three embodiments of different drive transmission configurations for a four wheel electric vehicle including a transmission that drives two wheel motors, and a transmission that drives a single wheel motor.

### DETAILED DESCRIPTION OF EMBODIMENTS OF THE INVENTION

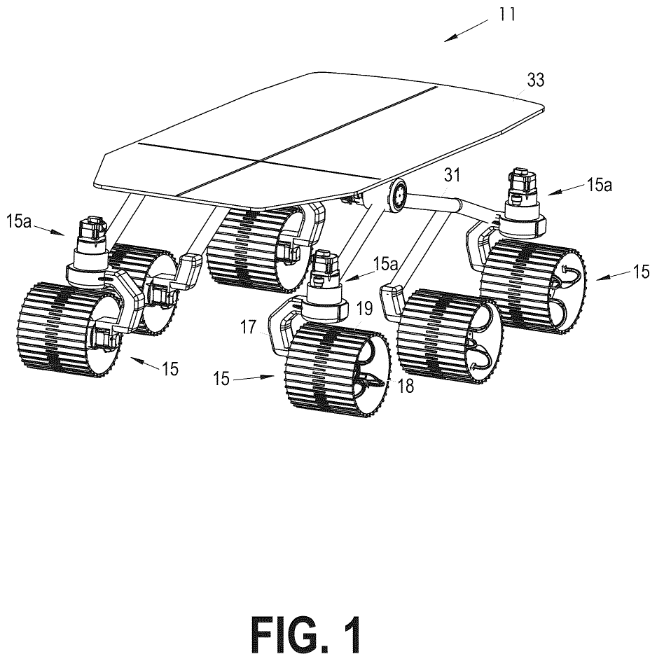

A planetary rover 11 is illustrated in FIG. 1 which supports a top structure 33, whereby the top structure 33 may include solar panels, power sources, sample drilling and sample collection systems, data collections systems, computers, and various other technologies to be used for planetary exploration. Additionally, the planetary rover 11 can be used to transport payloads including humans and cargo. A wheel drive transmission 15 is included with at least one wheel or can be used with all wheels for basic rotary motion of the wheel. The wheel includes a spoke structure 18 which connects the wheel drive 15 to the wheel tread structure 19 to ultimately rotate the wheel for forward and reverse motion. A second wheel drive transmission 15a is shown connected above the wheel tread structure 19 so that it can be used to rotate the first wheel drive transmission 15 as wheel drive transmission 15a is situated perpendicular to the first wheel drive transmission 15 such that the second wheel drive transmission 15a can turn the first wheel drive transmission 15 allowing the planetary rover to turn left or right. A wheel connecting structure 17 connects the first wheel drive transmission 15 with the second wheel drive transmission 15a. A larger chassis-to-wheel connecting structure called a rocker 31 is also included to connect the first wheel drive transmission 15 and the second wheel drive transmission 15a to the top structure 33.

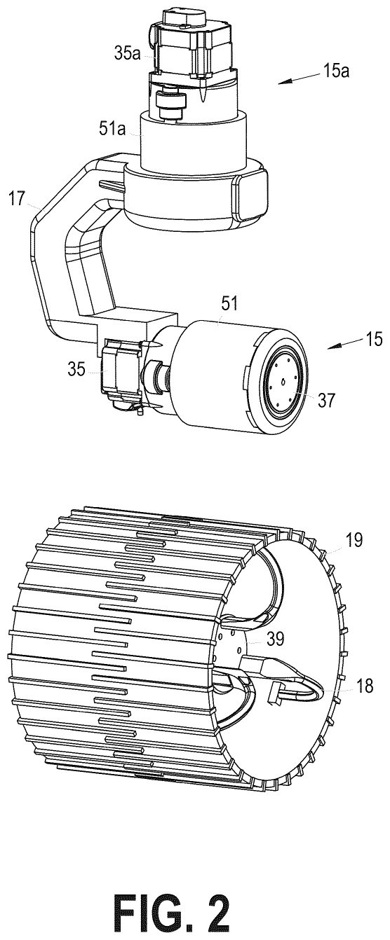

FIG. 2 shows a detail of the first wheel drive transmission 15 and the second wheel drive 15a with the wheel tread structure 19 and its connecting spoke structure 18 detached from the first wheel drive 15 at its spoke connecting plate 39 which ultimately attaches to wheel drive output plate 37. The core components of wheel drive transmission 15 include an actuator 35, a transmission 51, and the output plate 37 which is a rotary component that outputs the motion of the actuator 35 and the transmission 51. Similarly for wheel drive transmission 15a, an actuator 35a is included with a transmission 51a that may operate with the same or similar components to wheel drive transmission 15.

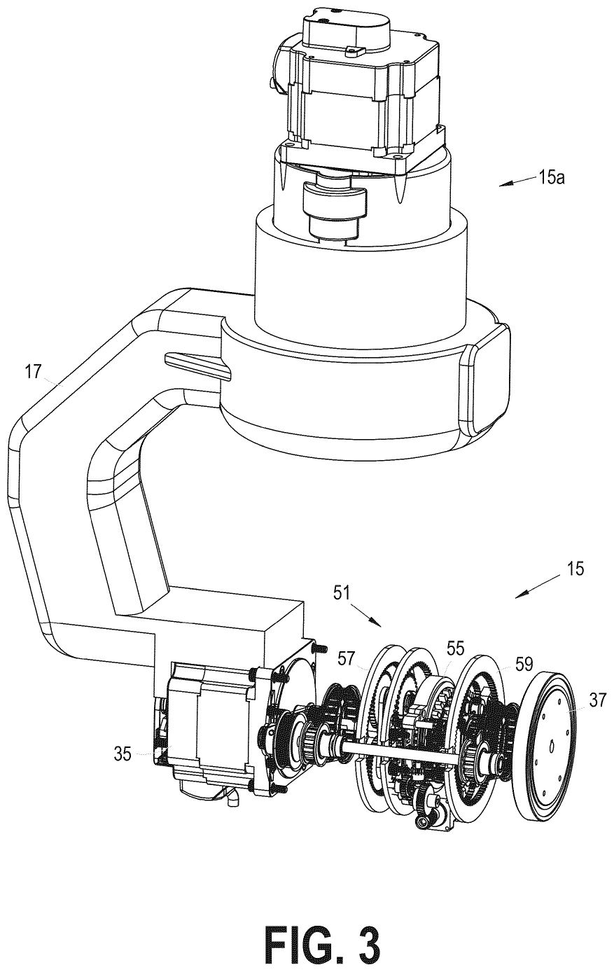

FIG. 3 illustrates the internal components of wheel drive 15 and its transmission 51, where the components for a variable speed transmission are revealed. The variable speed transmission can operate with two speeds as it is shown in this diagram, or with more than two speeds. A gear selection clutch 55 is included which switches the output of the transmission 51 from one gear set 57 to a second gear set 59, which ultimately provides a rotary output to output plate 37. The input motion for a rover may also use chain with pulleys as they are more sustainable for extreme environments. The gear selection clutch 55 can be activated automatically through feedback from sensors located along any part of the wheel or internal to the wheel drive such as along an internal shaft or connected to the output plate 37. A strain gauge or any other variation of a torque sensor, for example, could be used to provide feedback to indicate which gear set the clutch would need to be engaged with. The gear set may have epicyclic gearing, standard spur gear trains, or any other kind of gearing such as strain wave gearing. Because the wheel drive 15 or 15a can change its speed and torque output, this can provide advantages to optimizing motion of the planetary rover 11 along rough or steep terrain and can also provide greater power efficiency and conservation of power. The gear selection clutch 55 may also be actuated by a secondary actuator that utilizes a gearing system to move gear selection clutch 55 where there is no backlash, such as through a worm drive, a ball-screw mechanism, or a cylinder mechanism with a spiraling slot to provide axial motion to the clutch 55 as the cylinder is rotated. A gearing system may also be used to translate the motion of the clutch on one side to the other such as with a partial gear that is located concentrically and along the edge of the shell structure for the transmission 51 Planetary rover 11 can also be used for terrestrial use on earth as well as on other planets, but the same basic configuration may be used for electric vehicles on roadways where the wheel drive 15 or 15a can be configured to drive a rubber-based inflatable wheel such as those commonly used in motor vehicles and electric vehicles. The actuator 35 can also be connected to the transmission 51 through a belt or a chain, and the output of the transmission may also be connected to the wheel and wheel tread structure 19 or a typical rubber-based inflatable wheel through a belt or chain as well.

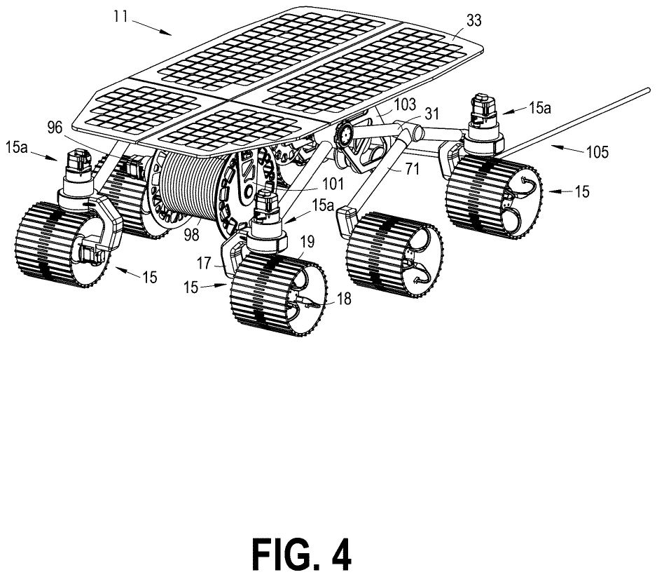

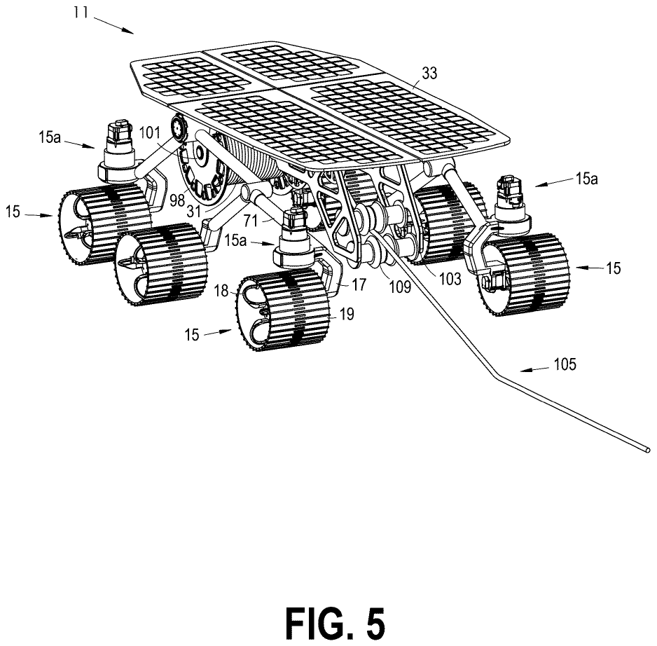

The same basic rover configuration as shown in FIG. 1 is shown in FIG. 4, but with solar panels integrated and a winch and cable deployment system. The solar panels can be seen integrated with the top structure 33 and the winch can be seen hanging below the top structure 33 whereby a winch support structure 101 is shown holding the cable spool 98 that is driven by a transmission 96 that operates like the variable speed wheel drive transmissions 15 and 15a. Transmission 96 may also be configured to have a single fixed gear reduction. A secondary cable deployment feed structure 103 also hangs from below the top structure 33 such that it can deploy the cable 105 to the ground. It is also important to note that a digging tool may be integrated near where the cable deployment feed sits so that it can provide a channel in the ground for the cable 105 to sit within. A bogie 71 wheel structure is also highlighted as this is one method for providing support and suspension of the rover's wheels. In FIG. 5, the back side of the rover shown in FIG. 4 highlights the cable deployment output feed system. This includes the cable deployment feed output 109 which helps guide the cable to land securely on the ground below without being caught or entangled, and is ultimately supported by the cable deployment feed structure 103. The underside of the same rover configuration is shown in FIGS. 4 and 5 to better highlight its cable deployment system as well as its sensor and electronics housing 115. The sensor and electronics housing 115 can house a variety of cameras and other sensors such as a spectrometer to help enhance navigation and sample analysis, especially if the rover is equipped with a channel digging tool to lay the cable in. The cameras may also be integrated with computer vision techniques so that the varying terrain that the rover is about to traverse can indicate to the gear election clutch 55 about whether or not pick a higher torque output with a slower speed or a lower torque output with a higher speed.

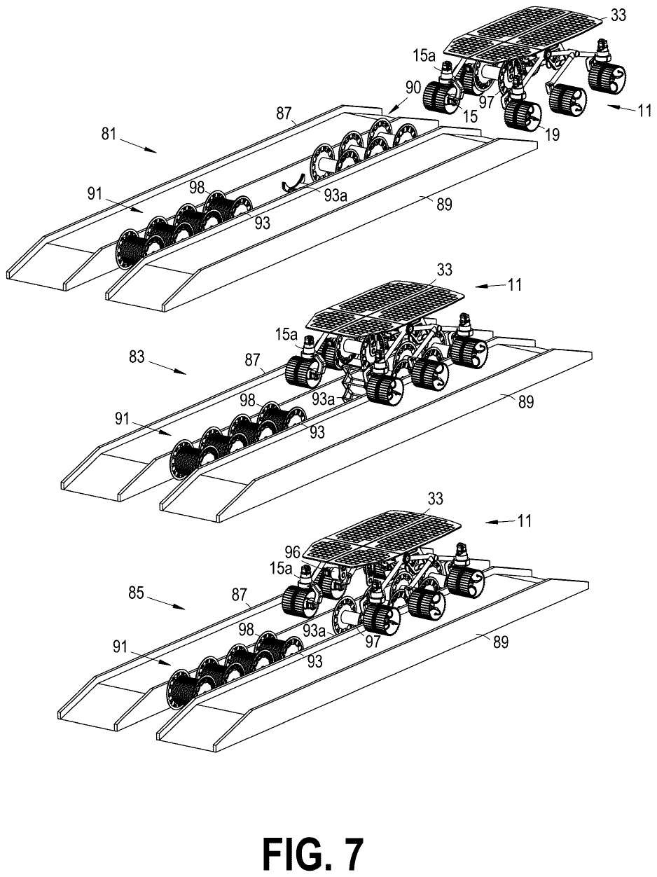

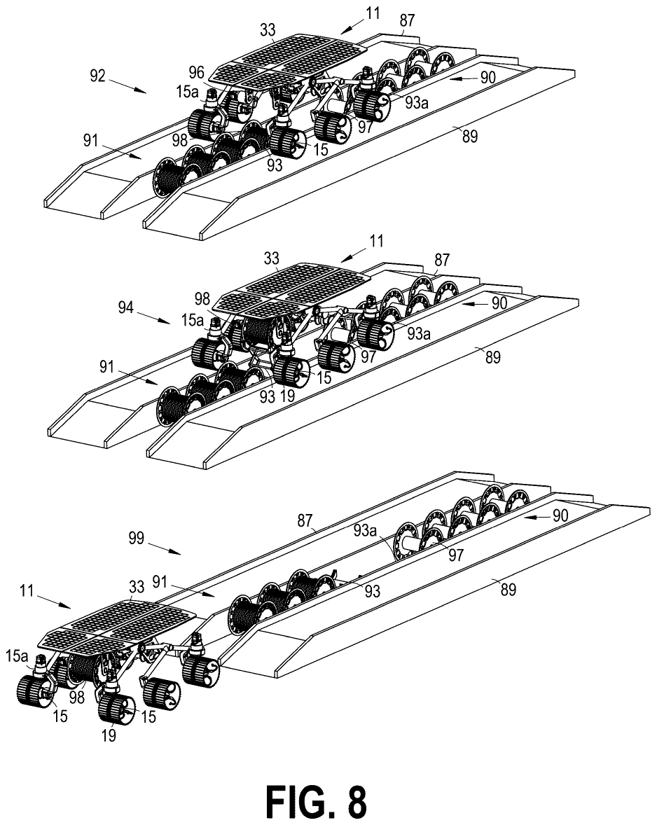

In FIG. 7 the cable spool loading system is shown in a three phase sequence 81, 83, and 85 where the emptied cable spool 97 is ejected from the rover. An empty cable spool cluster 90 is shown where the rover drives onto ramps 87 and 89 to highlight how this system can accommodate the ejection and loading of several cable spools. A cable spool lift ejector 93a can also be seen on the first half of the cable spool loading system which, in sequence 83, is shown grabbing emptied cable spool 97. A loaded cable spool cluster 91 is highlighted to illustrate that the loading system can accommodate multiple cable spools which can also be loaded in from the back end between ramps 87 and 89. Ultimately, loaded cable spool 98 is loaded to rover 11 through the cable spool lift loader 93 shown on the second half of the loading system. The loading of cable spool 98 is further highlighted from FIG. 8 in sequence diagrams 92, 94, and 99 where the rover 11 is initially shown driving up with its winch support structure 101 shown vacant of the cable spool, and then later in sequences diagrams 94 and 99 after it has been loaded through spool load lifter 97.

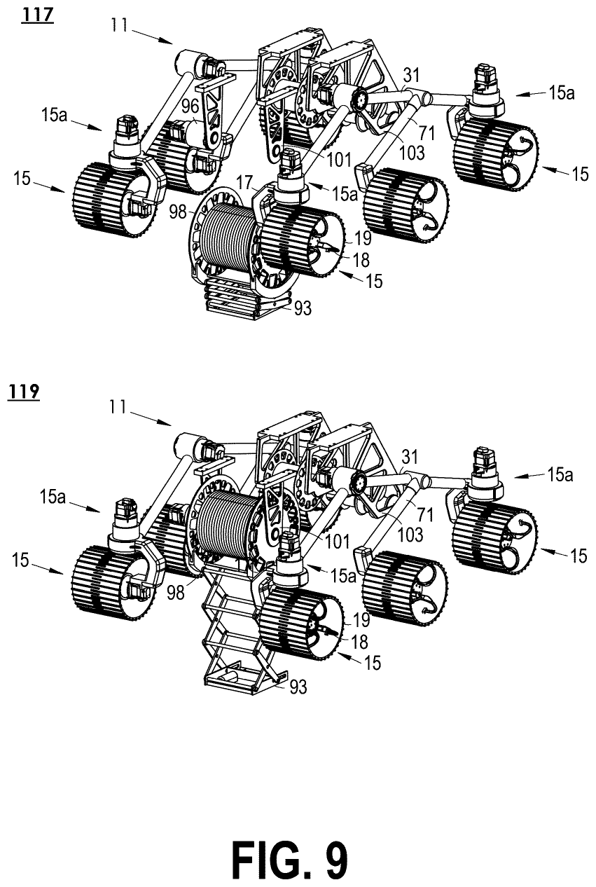

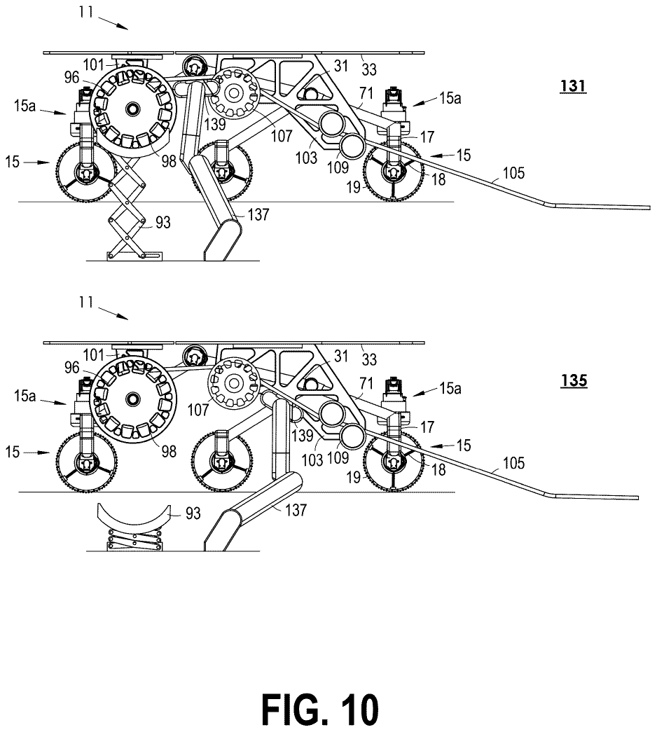

FIG. 9 shows the rover without its top structure to highlight how the cable spool lift loader 93 operates by lifting the cable spool 98 into place where it's shown in a retracted state in the top diagram 117 and in an extended state to load the cable spool 98 in the second diagram 119. It is important to also note that an engagement mechanism may be integrated as part of the winch support structure 101 in order to lock each loaded cable spool into place. This could include a small actuator with an appropriate gearing or ratcheting system to ensure that the spool is locked in place. FIG. 10 shows a side sectional view of the rover 11 and cable spool lift loader 93 in an extended loading state from the top diagram 131 with a robotic arm 137 shown to the right guiding the cable into the deployment feed system with its cable guide end effector 139, and then below with cable spool lift loader 93 in a retracted state and the robot arm 137 further guiding the cable into the deployment feed system through its cable guide end effector 139. Cable roller guide 107 is also shown supporting the cable 105 in diagrams 131 and 135.

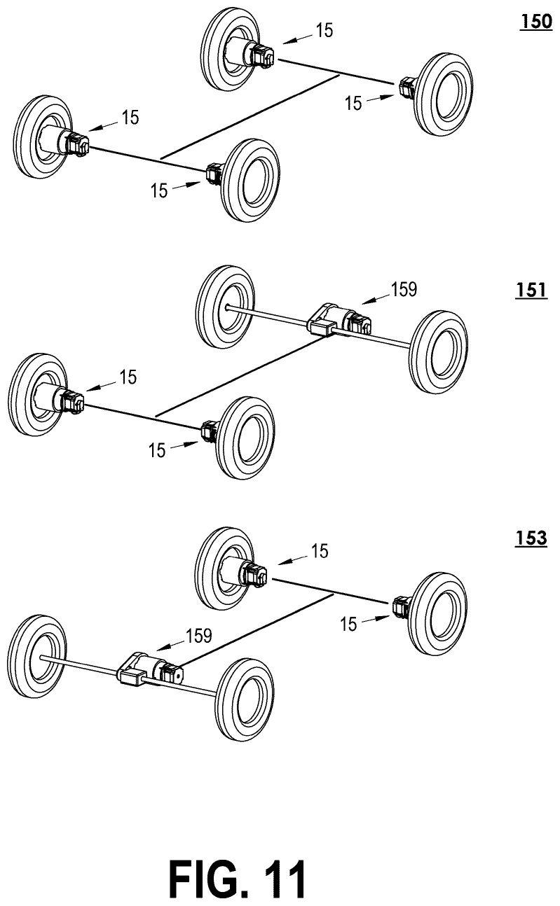

FIG. 11 shows three embodiments of different drive transmission configurations for a four-wheel electric vehicle including a transmission that drives two wheel motors, and a transmission that drives a single wheel motor. In the first embodiment 150, all four wheels are driven by their own variable speed wheel drive transmission 15. In the second diagram 151, the two back wheels are driven by a larger variable speed transmission 159 while the front two wheels are each driven by their own dedicated variable speed wheel drive transmission 15. In the third embodiment 153 the two front wheel are driven by the larger variable speed transmission 159 while the two back wheels are driven by their own dedicated variable speed wheel drive transmission 15. Further configuration may be implemented such as having only two wheels on the front or back utilizing the variable speed wheel drive transmission 15 as well as having the larger variable speed transmission 159 on the back two wheels and a second on the front two wheels.

While certain features of the invention have been illustrated and described herein, many modifications, substitutions, changes, and equivalents will now occur to those of ordinary skill in the art. It is, therefore, to be understood that the appended claims are intended to cover all such modifications and changes that fall within the true spirit of the invention.

1. A wheeled vehicle comprising:
a first wheel and a transmission associated with the first wheel, the transmission having multiple gear sets;
wherein the gear sets include a gear selection clutch, such that as the wheeled vehicle traverses a terrain, the gear selection clutch can engage with the most appropriate gear set to optimize the motion or power usage of the vehicle.

2. The wheeled vehicle of claim 1, wherein the gear set is made up of strain-wave gearing.

3. The wheeled vehicle of claim 1, wherein the gear set is made up of epicyclic gearing.

4. The wheeled vehicle of claim 1, wherein the gear set is made up of cycloidal gearing.

5. The wheeled vehicle of claim 1, wherein the gear set is made up of a combination of epicyclic gearing and strain-wave gearing.

6. The wheeled vehicle of claim 1, wherein the gear set is made up of a combination of epicyclic gearing and cycloidal gearing.

7. The wheeled vehicle of claim 1, wherein the gear set is made up of a combination of strain-wave gearing and cycloidal gearing.
